(19) United States
(12) Patent Application Publication
(10) Pub. No.: US 2026/0127761 A1
(43) Pub. Date: May 7, 2026

(54) VEHICLE CONTROL APPARATUS AND VEHICLE CONTROL METHOD

(71) Applicants: Hyundai Motor Company, Seoul (KR); Kia Corporation, Seoul (KR)

(72) Inventors: Seok Beom SONG, Hwaseong-Si (KR); Deuk Hyeon Kim, Hwaseong-Si (KR)

(73) Assignees: Hyundai Motor Company, Seoul (KR); Kia Corporation, Seoul (KR)

(21) Appl. No.: 19/214,489

(22) Filed: May 21, 2025

(30) Foreign Application Priority Data
Nov. 4, 2024 (KR) 10-2024-0154581

(51) Int. Cl. G06T 7/73; G06T 7/20

(52) U.S. Cl. CPC G06T 7/74; G06T 7/20; G06T 2207/30256

(57) ABSTRACT

A vehicle control apparatus includes first and second camera, and a processor that recognizes the first and second images to assist driving of a vehicle. The processor is configured to predict a movement of a reference point belonging to the first image captured at a first timing based on behavior information of the vehicle to determine an estimated position of the reference point at a second timing, determine a slope of a road surface around the vehicle based on a difference between the estimated position and a detected position of the reference point in the first image captured at the second timing, and when the slope of the road surface is greater than or equal to a predetermined level, perform calibration with respect to a difference between first position coordinates of the reference point in the first image and second position coordinates of the reference point in the second image.

### CROSS-REFERENCE TO RELATED APPLICATION

The present application claims priority to Korean Patent Application No. 10-2024-0154581, filed on Nov. 4, 2024, the entire contents of which is incorporated herein for all purposes by this reference.

### BACKGROUND OF THE PRESENT DISCLOSURE

### Field of the Present Disclosure

The present disclosure relates to a vehicle control apparatus and a method thereof, and to a technique for determining the slope of a road surface based on images obtained by a vehicle.

### Description of Related Art

An autonomous vehicle refers to a vehicle capable of operating independently without any input from a driver or passenger. The autonomous driving system (Automated Vehicle & Highway Systems) refers to a system that monitors and controls such autonomous vehicles to enable their self-driving operation. Additionally, technologies have been proposed to monitor the exterior of the vehicle and operate various driving assistance systems based on the monitored external environment to assist the driver.

Autonomous vehicles or vehicles equipped with driving assistance systems may utilize methods of performing artificial intelligence learning with images of the vehicle's surroundings as a means of monitoring the surroundings of the vehicle. For example, a camera mounted on a vehicle may be used to obtain images of the surroundings of the vehicle, and artificial intelligence learning is performed with the obtained images. The artificial intelligence network used to perform learning with images may perform object detection, semantic segmentation, depth map estimation, lane detection, or the like, depending on the purpose.

To minimize blind spots during the process of capturing images of the external environment, vehicles may utilize two or more cameras. The use of two or more cameras to obtain images of the external environment may result in overlapping areas where the angles of view of different cameras overlap. Within an overlapping area, the same object needs to be determined to match the same coordinates. However, when there is a slope on the road surface, the same object may be represented by different coordinates in cameras.

When the coordinate values obtained by different cameras are different, the accuracy of image recognition is reduced and errors in autonomous driving or driving assistance systems based on image recognition may occur.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a vehicle control apparatus and method capable of enhancing the accuracy of image recognition-based autonomous driving or driver assistance systems.

Various aspects of the present disclosure are directed to providing a vehicle control apparatus and method capable of improving the reliability of image recognition by more accurately matching images obtained from a plurality of cameras.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a vehicle control apparatus includes a first camera that obtains a first image in a range of a first field of view, a second camera that obtains a second image in a range of a second field of view, and a processor that recognizes the first and second images to assist driving of a vehicle. The processor is configured to predict a movement of a reference point belonging to the first image captured at a first timing based on behavior information of the vehicle to determine an estimated position of the reference point at a second timing, determine a slope of a road surface around the vehicle based on a difference between the estimated position and a detected position of the reference point in the first image captured at the second timing, and when the slope of the road surface is greater than or equal to a predetermined level, perform calibration with respect to a difference between first position coordinates of the reference point in the first image and second position coordinates of the reference point in the second image.

In an exemplary embodiment of the present disclosure, the processor may convert the first image into a top-view image, and determine specified coordinates in the top-view image as the reference point.

In an exemplary embodiment of the present disclosure, the behavior information of the vehicle may include a yaw rate of the vehicle and a speed of the vehicle.

In an exemplary embodiment of the present disclosure, the processor is configured to determine the estimated position based on a rotation matrix based on the yaw rate and a motion transformation matrix based on the speed.

In an exemplary embodiment of the present disclosure, the processor may count a number of errors in which a difference between the estimated position and the detected position of the reference point in the first image, obtained at the second timing, falls within a predetermined range, and determine the slope of the road surface when the number of errors exceeds a threshold count.

In an exemplary embodiment of the present disclosure, the processor may reduce the threshold count as a speed of the vehicle decreases.

In an exemplary embodiment of the present disclosure, the processor is configured to determine a mismatch between the first position coordinates and the second position coordinates based on a difference between a height value of the first position coordinates and a height value of the second position coordinates.

In an exemplary embodiment of the present disclosure, the processor may obtain first normalized coordinates based on the first position coordinates, obtain second normalized coordinates based on the second position coordinates, and determine the mismatch between the first position coordinates and the second position coordinates based on a height error between a first actual height of first world coordinates obtained by converting the first normalized coordinates and a second actual height of second world coordinates obtained by converting the second normalized coordinates.

In an exemplary embodiment of the present disclosure, the processor is configured to determine calibrated coordinates of the reference point based on a weighted average by a distance between the first position coordinates and the second position coordinates.

In an exemplary embodiment of the present disclosure, the processor is configured to determine a third axis coordinate of the calibrated coordinates based on a distance difference between the first position coordinates and the second position coordinates in a plane determined by a first axis and a second axis.

According to an aspect of the present disclosure, a vehicle control method includes predicting a movement of a reference point belonging to the first image captured by a first camera at a first timing based on behavior information of a vehicle to determine an estimated position of the reference point at a second timing, determining a slope of a road surface around the vehicle based on a difference between the estimated position and a detected position of the reference point in the first image captured at the second timing, and when the slope of the road surface is greater than or equal to a predetermined level, performing calibration with respect to a difference between first position coordinates of the reference point in the first image and second position coordinates of the reference point in a second image captured by a second camera to generate calibrated coordinates.

In an exemplary embodiment of the present disclosure, the determining of the estimated position of the reference point at the second timing may include converting the first image into a top-view image, and determining specified coordinates in the top-view image as the reference point.

In an exemplary embodiment of the present disclosure, the behavior information of the vehicle includes a yaw rate of the vehicle and a speed of the vehicle.

In an exemplary embodiment of the present disclosure, the determining of the estimated position of the reference point at the second timing may include determining the estimated position based on a rotation matrix based on the yaw rate and a motion transformation matrix based on the speed.

In an exemplary embodiment of the present disclosure, the determining of the slope of the road surface may include counting a number of errors in which a difference between the estimated position and the detected position of the reference point in the first image, obtained at a second timing, falls within a predetermined range, and determining the slope of the road surface when the number of errors exceeds a threshold count.

In an exemplary embodiment of the present disclosure, the counting of the number of errors may include reducing the threshold count as a speed of the vehicle decreases.

In an exemplary embodiment of the present disclosure, the generating of the calibrated coordinates may include determining a mismatch between the first position coordinates and the second position coordinates based on a difference between a height value of the first position coordinates and a height value of the second position coordinates.

In an exemplary embodiment of the present disclosure, the determining of the mismatch between the first position coordinates and the second position coordinates may include obtaining first normalized coordinates based on the first position coordinates, obtaining second normalized coordinates based on the second position coordinates, and determining the mismatch between the first position coordinates and the second position coordinates based on a height error between a first actual height of first world coordinates obtained by converting the first normalized coordinate and a second actual height of second world coordinates obtained by converting the second normalized coordinates.

In an exemplary embodiment of the present disclosure, the generating of the calibrated coordinates may include generating calibrated coordinates of the reference point based on a weighted average by a distance between the first position coordinates and the second position coordinates.

In an exemplary embodiment of the present disclosure, the generating of the calibrated coordinates may include determining a third axis coordinate of the calibrated coordinates based on a distance difference between the first position coordinates and the second position coordinates in a plane determined by a first axis and a second axis.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram illustrating a configuration of a vehicle control apparatus according to an exemplary embodiment of the present disclosure;

FIG. 2 is a flowchart for describing a vehicle control method according to an exemplary embodiment of the present disclosure.

FIG. 3 is a diagram for describing an example of camera mounting;

FIG. 4 is a diagram for describing a method for recognizing a parking slot by an exemplary embodiment of the present disclosure;

FIG. 5 is a diagram for describing a coordinate system utilized in an exemplary embodiment of the present disclosure;

FIG. 6 is a diagram for describing a method for calibrating parking slot positions according to an exemplary embodiment of the present disclosure;

FIG. 7 is a diagram for describing a method for detecting a road slope according to an exemplary embodiment of the present disclosure;

FIG. 8 is a diagram for describing a process for matching images obtained by cameras; and

FIG. 9 is a diagram illustrating a computing system according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, with reference to the accompanying drawings, various exemplary embodiments of the present disclosure will be described in detail so that those of ordinary skill in the art may easily carry out the present disclosure. However, the present disclosure may be embodied in various forms and should not be construed as limited to the exemplary embodiments set forth herein.

Furthermore, in describing the exemplary embodiment of the present disclosure, a detailed description of well-known features or functions will be ruled out in order not to unnecessarily obscure the gist of the present disclosure. In the drawings, portions not related to the description are omitted, and like reference numerals refer to like elements throughout the specification.

In an exemplary embodiment of the present disclosure, it will be understood that when an element is referred to as being “connected to”, “coupled to”, or “combined with” another element, the element may be directly connected or coupled to or combined with the another element or intervening elements may be present therebetween. It will be further understood that the terms “comprise”, “include” or “have” when used in an exemplary embodiment of the present disclosure specify the presence of stated elements but do not preclude the presence or addition of one or more other elements.

In an exemplary embodiment of the present disclosure, terms such as first and second are used only for distinguishing one element from other elements, and do not limit the order or importance of the elements unless specifically mentioned. Accordingly, within the scope of the present disclosure, a first component in various exemplary embodiments of the present disclosure may be referred to as a second component in another exemplary embodiment of the present disclosure, and similarly, the second component in various exemplary embodiments of the present disclosure may be referred to as a first component in another exemplary embodiment of the present disclosure.

In an exemplary embodiment of the present disclosure, distinct elements are only for clearly describing their features, and do not mean that the elements are separated necessarily. That is, a plurality of elements may be integrated to form a single hardware or software unit, or a single element may be distributed to form a plurality of hardware or software units. Accordingly, such integrated or distributed embodiments are included in the scope of the present disclosure, even if not otherwise noted.

In an exemplary embodiment of the present disclosure, elements described in the various exemplary embodiments of the present disclosure are not necessarily essential elements, and some elements may be optional. Accordingly, various exemplary embodiments including a subset of the elements described in an exemplary embodiment are also included in the scope of the present disclosure. Furthermore, various exemplary embodiments including other elements in addition to the elements described in the various exemplary embodiments of the present disclosure are also within the scope of the present disclosure.

In an exemplary embodiment of the present disclosure, expressions of positional relationships used in the specification, such as top, bottom, left, or right, are described for convenience of description, and when the drawings shown in the specification are viewed in reverse, the positional relationships described in the specification may also be interpreted in the opposite way.

In an exemplary embodiment of the present disclosure, each of the phrases “A or B,” “at least one of A and B,” “at least one of A or B,” “A, B or C,” “at least one of A, B and C,” and “at least one of A, B, or C” may include any one of items listed along with a relevant phrase, or any possible combination thereof.

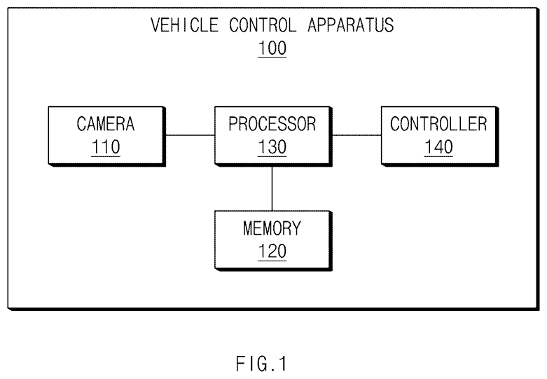

Hereinafter, various exemplary embodiments of the present disclosure will be described in detail with reference to FIGS. 1 to 7.

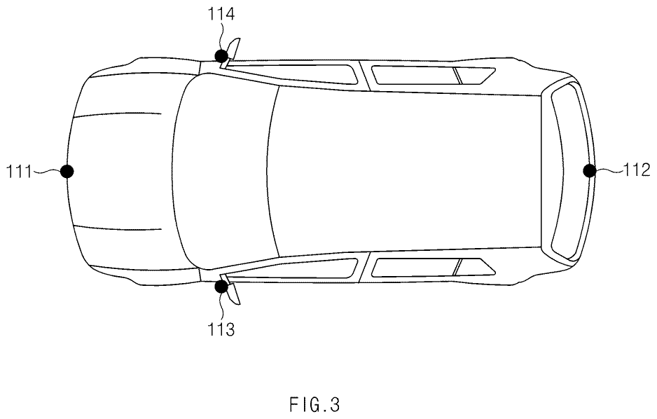

FIG. 1 is a diagram illustrating a configuration of a vehicle control apparatus according to an exemplary embodiment of the present disclosure, and FIG. 3 is a diagram for describing an example of camera mounting.

Referring to FIG. 1 and FIG. 3, a vehicle control apparatus 100 according to an exemplary embodiment of the present disclosure may include a camera 110, a memory 120, and a processor 130.

The camera 110 may be for obtaining an external image of the vehicle, and the camera 110 may be a wide-angle camera to obtain a wide field of view. As shown in FIG. 3, the camera 110 may include a front camera 111, a rear camera 112, a left-side camera 113, and a right-side camera 114, and the location where the camera 110 is mounted may not be limited to these locations.

The memory 120 may store algorithms for the operation of the processor 130 and an AI processor. The memory 120 may be implemented using a hard disk drive, flash memory, electrically erasable programmable read-only memory (EEPROM), static RAM (SRAM), ferro-electric RAM (FRAM), phase-change RAM (PRAM), magnetic RAM (MRAM), Dynamic Random Access Memory (DRAM), Synchronous Dynamic Random Access Memory (SDRAM), Double Data Rate-SDRAM (DDR-SDRAM), and the like.

The processor 130 may be connected to the camera 110 and the memory 120 and may recognize an image obtained by the camera 110 to monitor the external environment of a vehicle VEH.

The processor 130 may convert the image into a top-view image, and based on the top-view image, identify a specified shape marked on a road surface. For example, the processor 130 may identify, for example, parking slots drawn on the road surface from the image obtained by the camera 110.

The processor 130 may use a camera calibration in converting the image to a top-view image, and the camera calibration may be determined assuming that the road surface on which the vehicle VEH is present has no slope. Therefore, when there is a slope on the road surface where the vehicle is located, an error may occur in measuring the position of an entrance point in a parking slot. An error in the position of the entrance point may result in an error in generating a path for autonomous parking, and it may take a lot of time to determine the path for autonomous parking, which may deteriorate the performance of autonomous parking.

The processor 130 may calibrate the coordinates of an object detected in the image to obtain an accurate position of the entrance point, even when there is a slope on the road surface on which the vehicle VEH is located. To the present end, the processor 130 may be configured to determine whether the road surface around the vehicle VEH has a slope based on whether an image predicted based on the behavioral information of the vehicle VEH matches the image obtained by the camera 110. When the slope of the road surface is greater than or equal to a predetermined level, the processor 130 may calibrate the coordinates of the image to reflect the slope of the road surface.

The processor 130 may perform image-based artificial intelligence learning to detect parking lines in the images obtained by the camera 110. To the present end, the processor 130 may include an artificial intelligence (hereinafter referred to as AI) processor. The AI processor may learn a neural network using a pre-stored program. A neural network for detecting a target vehicle and a dangerous vehicle may be designed to simulate a human brain structure on a computer, and may include a plurality of network nodes having weights that simulate neurons of a human neural network. The plurality of network nodes may transmit and receive data according to their connection relationships to simulate synaptic activity of neurons that transmit and receive signals through synapses. The neural network may include a deep learning model developed from a neural network model. In the deep learning model, a plurality of network nodes may exchange data according to convolution connection relationships while being located in different layers. Examples of neural network models may include various deep learning techniques such as deep neural networks (DNN), convolutional deep neural networks (CNN), recurrent Boltzmann machines (RNN), restricted Boltzmann machines (RBM), deep belief networks (DBN) and deep Q-networks.

The processor 130 may be configured for controlling a controller 140 based on a scenario involving parking lines obtained from the image. For example, the controller 140 may be controlled to perform autonomous parking along the recognized parking lines.

The controller 140 is configured for controlling the behavior of the vehicle based on a control signal from the processor 130, and may include a steering controller, an engine controller, a brake controller, and a transmission controller.

The steering controller may be classified into a Hydraulic Power Steering (HPS) system that controls steering using hydraulic pressure generated by a hydraulic pump and a Motor Driven Power Steering (MDPS) system that controls steering using output torque of an electric motor (hereinafter referred to as ‘MDPS’).

The engine controller is an actuator that controls a vehicle's engine, which controls the acceleration of the vehicle. The engine controller may be implemented as an engine management system (EMS). The engine controller may be configured for controlling a driving torque of the engine according to accelerator pedal position information output from an accelerator pedal position sensor. The engine controller may be configured for controlling engine output to follow the driving speed of the vehicle requested from the processor 130 during autonomous driving.

The brake controller may be an actuator that controls deceleration of the vehicle, and may be implemented with an Electronic Stability Control (ESC). The brake controller may be configured for controlling a brake pressure to follow the target speed requested from the processor 130. That is, the brake controller may be configured for controlling deceleration of the vehicle.

The transmission controller is an actuator for controlling the transmission of a vehicle, and may be implemented with an electric shifter such as shift-by-wire (SBW). The transmission controller may be configured for controlling the shifting of the vehicle based on a range of gear positions and gear states.

Herein, in an exemplary embodiment of the present disclosure, the processor 130 and the controller 140 may be implemented as separate processors or as a single integrated processor.

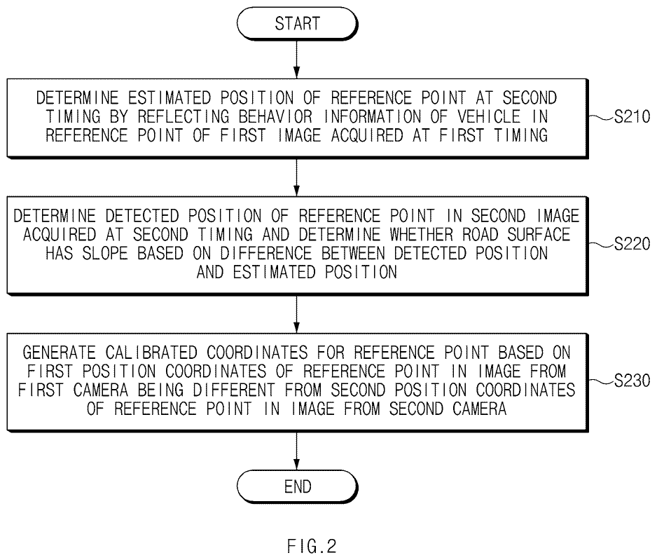

FIG. 2 is a flowchart for describing a vehicle control method according to an exemplary embodiment of the present disclosure. FIG. 2 may be a process performed by the processor shown in FIG. 1.

Referring to FIG. 2, a vehicle control method according to an exemplary embodiment of the present disclosure will be described below.

In S210, a reference point may be obtained from a first image captured at a first timing, and the movement of the reference point may be predicted to determine an estimated position.

The first image may be a single image frame obtained by a first camera, and the first camera may be any one of the cameras 111, 112, 113, and 114 shown in FIG. 3.

The reference point may be a specified position in the image, and may represent a single pixel included in a specified object. For example, the reference point may be a position which is included in a parking slot, and may be set as an entrance point to the parking slot.

The reference point may be coordinates in a top-view image. The coordinates in the top-view image may be coordinates in a pixel coordinate system. The ratio of the spacing between pixels in the top-view image to the actual distance in the world coordinate system may be preset.

The estimated position may be the coordinates of the reference point at a second timing after a certain period has elapsed from a first timing and may be the coordinates in the top-view image. The estimated position may be distinct from the coordinates in an image captured by the camera 110 and may represent predicted coordinates reflecting movement of the reference point based on the vehicle's behavior information. The vehicle's behavior information may include yaw rate information of the vehicle VEH and speed information of the vehicle VEH. The processor 130 may be configured to determine the estimated position based on a rotation matrix based on the yaw rate and a motion transformation matrix based on velocity.

In S220, the processor 130 may be configured to determine whether the road surface on which the vehicle VEH is traveling has a slope based on a difference between the estimated position and a detected position of the reference point in the first image captured at the second timing.

The second timing may be a timing after a certain time period has elapsed from the first timing, and the first timing and the second timing may be set based on a frame rate of the image. For example, the first timing may be a time point when the k-th image frame (where “k” is a natural number) is captured, and the second timing may be a time point when the (k+i)-th (where “i” is a natural number) image frame is captured.

The Detected Position May Represent Coordinates of the First Reference Point Captured at the Second Timing, and May be Coordinates in the Top-View Image.

The processor 130 may be configured to determine that the road surface has a slope when a distance difference between the estimated position and the detected position falls within a predetermined range. To the present end, a first threshold and a second threshold for determining the predetermined range may be preset, and the processor 130 may be configured to determine that the road surface has a slope when the distance difference is greater than or equal to the first threshold and less than the second threshold.

Alternatively, the processor 130 may count the number of errors in which the distance difference falls within the predetermined range, and determine that the road surface has a slope when the number of errors exceeds a preset threshold count. The threshold count may be variable, and for example, as the vehicle's speed decreases, the size of the threshold count may also decrease.

In S230, when the slope of the road surface is greater than or equal to a certain level, the processor 130 may compensate for the difference between the first position coordinates of the reference point in the first image and the second position coordinates of the reference point in the second image.

The first position coordinates and the second position coordinates may be determined based on images captured at the same timing.

The processor 130 may be configured to determine whether the road surface has a slope based on the difference between the height value of the first position coordinates and the height value of the second position coordinates. The height value may refer to a z-axis coordinate in the world coordinate system, and may be a coordinate value in a direction perpendicular to the road surface.

Hereinafter, specific embodiments of the present disclosure will be described below.

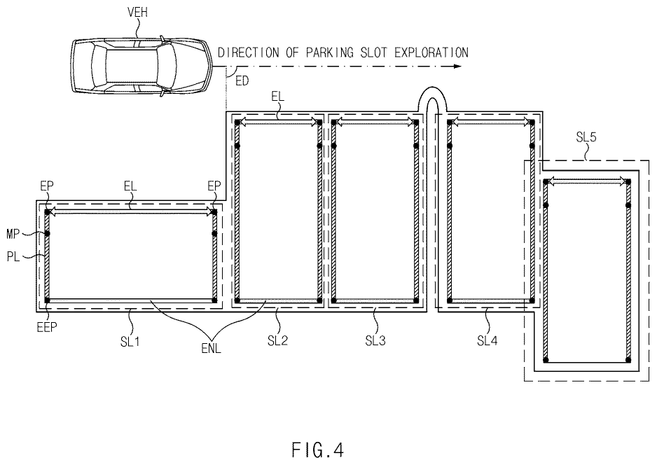

FIG. 4 is a diagram for describing a method for recognizing a parking slot by an exemplary embodiment of the present disclosure.

Referring to FIG. 4, the vehicle VEH may obtain an image of an external environment of the vehicle VEH using the camera 110, and determine parking slots SL1, SL2, SL3, SL4 and SL5 from the image. FIG. 4 illustrates parking slots including the first parking slot SL1 to the fifth parking slot SL5, which will hereinafter be referred to as a parking slot SL when referring to any of the parking slots.

The parking slot SL may refer to a predetermined zone for parking the vehicle VEH. The parking slot SL may include an entrance line EL, an end line ENL, a parking line PL, an entrance point EP, a midpoint MP, and an entrance end point EEP. The entrance line EL may refer to a line at which a vehicle enters a parking slot. Both end portions of the entrance line EL may be referred to as entrance points EP. The end line ENL may refer to the side that faces the entrance line EL. Both end portions of the end line ENL may be referred to as entrance end points EEP. The two sides adjacent to the entrance line EL in the parking slot SL may be referred to as the parking line PL. A point on the parking line PL may be referred to as the midpoint MP. The angle associated with an angle between the parking line PL and the vehicle may be referred to as an entrance line angle ED. When the parking slot SL is located to the right of the vehicle VEH, the entrance line angle ED may have a negative value. Additionally, when the parking spot SL is located to the left of the vehicle VEH, the entrance line angle may have a positive value.

The position of the entrance point EP of the parking slot SL illustrated in FIG. 4 may be a position in the world coordinate system.

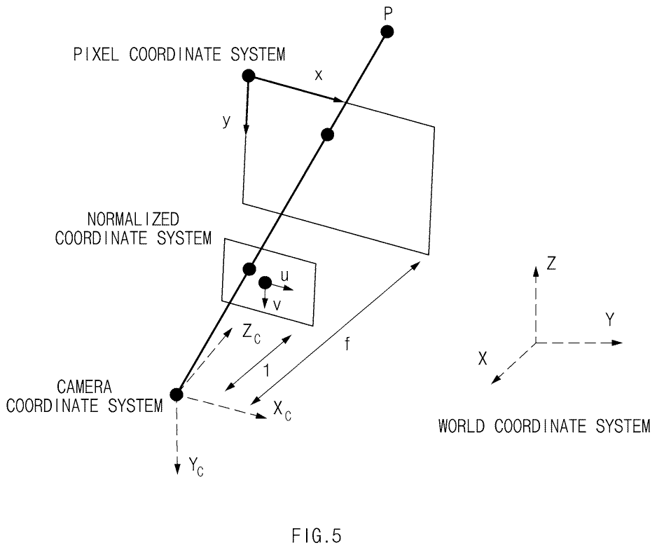

Based on camera calibration information, the processor 130 may convert the pixel coordinates of an image obtained by the camera 110 to xy coordinates in the world coordinate system. The conversion of the coordinate system will be described with reference to FIG. 5.

FIG. 5 is a diagram for describing a coordinate system utilized in an exemplary embodiment of the present disclosure.

The processor 130 may convert an image to a top-view image, and convert the coordinates of the top-view image to coordinates in a world coordinate system.

The world coordinate system may be a three-dimensional coordinate system used to represent the external environment of the vehicle VEH. In an exemplary embodiment of the present disclosure, the X-Y plane of the world coordinate system may be a plane parallel to the road surface on which the vehicle VEH is traveling, and the Z-axis may be in a direction perpendicular to the road surface on which the vehicle VEH is traveling. The X-axis may be determined as the direction of travel of the vehicle.

The camera coordinate system may be a three-dimensional coordinate system with the center of the lens of the camera 110 as the origin (0, 0, 0). In the camera coordinate system, the Zc-axis may correspond to the forward direction of the camera, the Yc-axis may correspond to the downward direction of the camera, and the Xc-axis may correspond to the rightward direction.

The pixel coordinate system may be a two-dimensional coordinate system for the image obtained by the camera 110, and the origin of the pixel coordinate system may be set to the left-most topmost point. The x-axis of the pixel coordinate system may be in the horizontal direction of the image, and the y-axis may be in the vertical direction of the image. In FIG. 5, f may be a focal length.

The normalized coordinate system may refer to a coordinate system in which the influence of the camera's intrinsic parameters is eliminated in the pixel coordinate system. The normalized coordinate system may be intended to generate an image plane with intrinsic parameters removed, which could otherwise cause issues in geometric analysis. The normalized coordinate system may comprise a u-axis and v-axis.

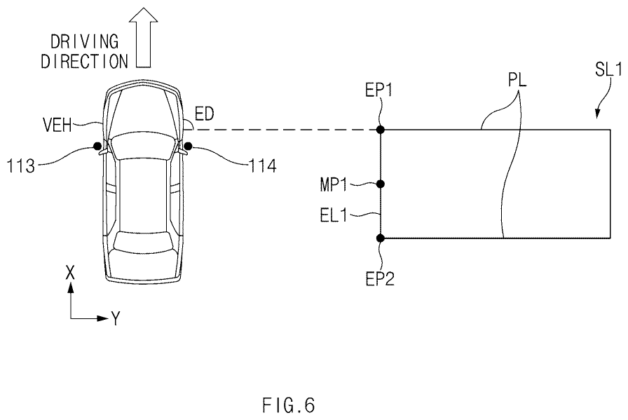

FIG. 6 is a diagram for describing a method for calibrating parking slot positions according to an exemplary embodiment of the present disclosure.

Referring to FIG. 6, to calibrate parking slot positions, the processor 130 may be configured to determine a difference between a midpoint MPI of an entrance line EL1 and the longitudinal position of the right-side camera 114 of the vehicle. The longitudinal direction may be the direction of travel of the vehicle VEH.

The processor 130 may be configured to determine a difference between a first entrance line measurement length and an entrance line reference length. The entrance line measurement length may be determined based on a coordinates of a first entrance point EP1 and a coordinates of a second entrance point EP2 in the image coordinate system. For example, entrance line measurement length can be obtained by calculating a Euclidean distance between the coordinates of the first entrance point EP1 and the coordinates of the second entrance point EP2. The entrance line reference length may refer to the standardized value of the entrance line for each type of predetermined parking slot (for example, a rectangular parking slot, a parallelogram parking slot, etc.).

The processor 130 may update a second entrance line tracking length generated in a previous frame when a difference between the midpoint MPI of the first entrance line EL1 and the longitudinal position of the right-side camera 114 of the vehicle is less than a first threshold and a difference between the first entrance line measurement length and an entrance line reference length is less than a second threshold. The tracking length may be obtained by tracking the entrance line measurement length. When a difference between the midpoint MPI of the first entrance line EL1 and the longitudinal position of the vehicle right-side camera 114 is less than a first threshold distance, it may mean that a distance between the right-side camera 114 and the first parking slot SL1 is closer by a certain distance in the longitudinal direction. That is, the method for calibrating parking slot positions may include updating the second entrance line tracking length when the vehicle VEH is adjacent to the first parking slot SL1 by less than a predetermined distance.

Additionally, when a difference between the first entrance line measurement length and the entrance line reference length is less than the second threshold length, it may mean that the first parking slot SL1 is not an irregular parking slot. In other words, when the difference between the entrance line reference length, which is a predetermined standardized value, and the first entrance line measurement length is less than the second threshold, the first parking slot SL1 may be one of regular parking slots. The method for calibrating parking slot positions may include updating the second entrance line tracking length when the first parking slot SL1 is not an irregular parking slot.

The method for calibrating parking slot positions may include generating the first entrance line tracking length by updating the second entrance line tracking length based on the second entrance line tracking length generated in the previous frame and the first entrance line measurement length generated in the current frame. The method for calibrating parking slot positions may include generating the first entrance line tracking length based on the second entrance line tracking length and the first entrance line measurement length using a certain filter. For example, the method for calibrating parking slot positions may include, but the present disclosure is not limited to, generating the first entrance line tracking length by inputting the second entrance line tracking length and the first entrance line measurement length into a Kalman filter to predict the first entrance line tracking length.

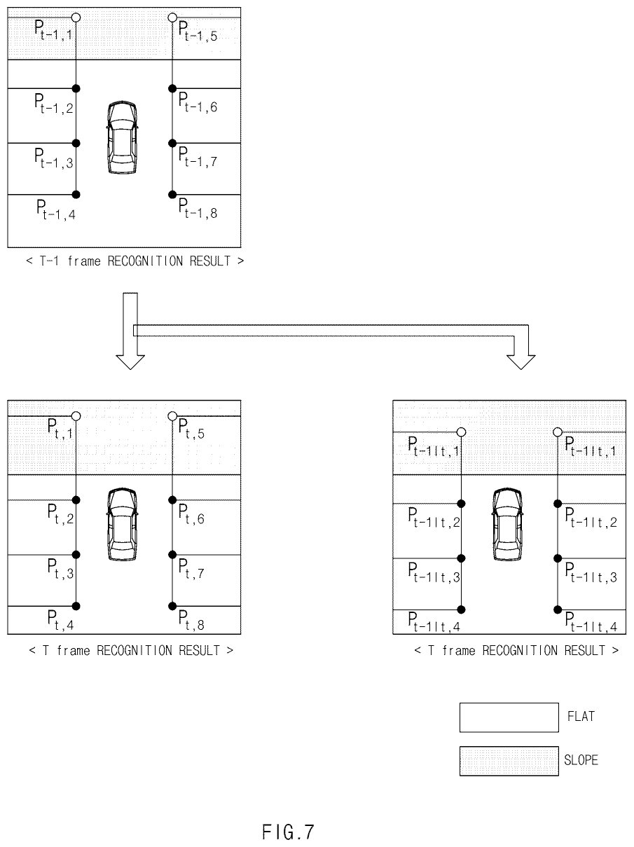

FIG. 7 is a drawing for describing a method for detecting a road slope according to an exemplary embodiment of the present disclosure. FIG. 7 may be a diagram for describing S210 and S220 illustrated in FIG. 2.

Referring to FIG. 7, a method for detecting a road slope by an exemplary embodiment of the present disclosure may be performed based on a difference between an estimated position of an entrance point and a detected position.

In FIG. 7, P_{t-1,i} may refer to coordinates of the i-th entrance point (i is a natural number) detected in the (t−1)-th image frame (t is a natural number greater than or equal to 2). FIG. 7 illustrates first to eighth entrance points. P_{t,i} may denote the coordinates of the i-th entrance point detected in a t-th image frame. Hereinafter, when the entrance point is not specified, the coordinates of the entrance point obtained in the (t−1)-th image frame may be represented by Pₜ₋₁, and the coordinates of the entrance point obtained in the t-th image frame may be expressed as Pₜ. The coordinates detected in the image may be referred to as the detection position.

P_{t-1|t} may denote coordinates that estimate the position of the entrance point in the t-th image frame based on the entrance point detected in the (t−1)-th image frame. In other words, when description is given with respect to the t-th image frame, P_{t-1|t} may be the coordinates of the entrance point estimated based on the previous image frame, and may be expressed as the estimated position in the t-th frame. Hereinafter, when the entrance point is not specified, the estimated position in the t-th image frame obtained based on the (t−1)-th image frame may be expressed as P_{t-1|t}.

Furthermore, the coordinates of the entrance point (Pₜ₋₁) obtained in the (t−1)-th image frame, that is, the estimated position (P_{t-1|t}) in the t-th image frame obtained based on the (t−1)-th image frame be expressed as [Equation 1].

$${P}_{t - 1} = {[ {x}_{t - 1} , {y}_{t - 1} ]}^{T} , {P}_{t - 1 \vert t} = {[ {x}_{t - 1 \vert t} , {y}_{t - 1 \vert t} ]}^{T} \qquad [ Equation 1 ]$$

In [Equation 1], T may be a transformation matrix.

The estimated position of the entrance point in the t-th frame may be obtained by reflecting the vehicle behavior information in the detected position of the entrance point in the (t−1)-th frame.

The vehicle behavior information may include a yaw rate of the vehicle VEH and a speed of the vehicle. The processor 130 may multiply the detected position of the entrance point in the (t−1)-th frame by a rotation matrix and add a motion transformation matrix proportional to the speed of the vehicle VEH to obtain the estimated position (P_{t-1|t}) for the entrance point in the t-th frame. For example, the processor 130 may obtain the estimated position of the entrance point based on the following [Equation 2].

$${P}_{t - 1 \vert t} = {R}_{t} * {P}_{t - 1} + {T}_{t} \qquad [ Equation 2 ]$$

In [Equation 2], Rₜ may denote the rotation matrix, and Tₜ may denote the motion transformation matrix. The rotation matrix (Rₜ) and the motion transformation matrix (Tₜ) may be expressed as [Equation 3].

$${R}_{t} = [ \begin{matrix}cos ( {θ}_{t} ) & sin ( {θ}_{t} ) \\ - sin ( {θ}_{t} ) & cos ( {θ}_{t} )\end{matrix} ] , {T}_{t} = {[ \frac{{v}_{t}}{{θ}_{t}} * sin ( {θ}_{t} ) , \frac{{v}_{t}}{{θ}_{t}} * ( 1 - cos ( {θ}_{t} ) ) ]}^{T} \qquad [ Equation 3 ]$$

In [Equation 3], θ may be the yaw rate of the vehicle. Further, the motion transformation matrix (Tₜ) may be expressed as the product of the rotation matrix (Rₜ) and the vehicle speed (Vₜ).

The processor 130 may be configured to determine whether the distance difference between the estimated position and the detected position falls within a predetermined range, and count the number of errors in which the distance difference falls within the predetermined range. Accordingly, the processor 130 may be configured to determine that the road surface has a slope when the counted number of errors exceeds a threshold count.

The threshold count may vary depending on the speed of the vehicle.

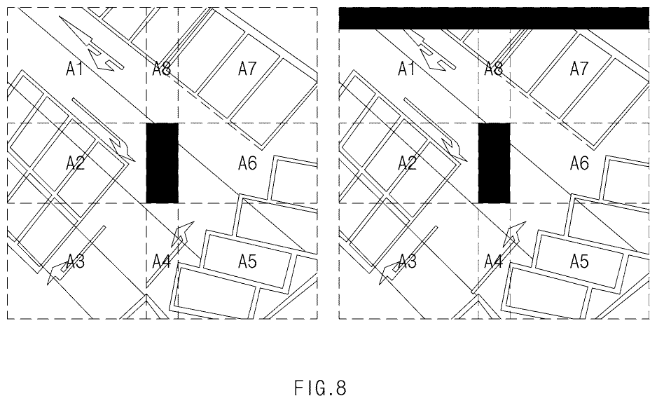

Furthermore, the threshold count may vary depending on the turning direction of the vehicle. For example, the threshold count which is compared to the difference between an estimated position and a detected position for entrance points located in the direction in which the vehicle VEH is turning may be set to be greater than the threshold count which is compared to the difference between the estimated position and the detected position for entrance points located in the opposite direction. In other words, when the vehicle VEH is turning left, a threshold count for determining a slope for the first area Al and the third area A3 shown in FIG. 8 may be set to be greater than a threshold count for determining a slope for the fifth area A5 and the seventh area A7. The areas illustrated in FIG. 8 are diagrams for describing overlapping areas in a process of matching images obtained by two or more cameras.

FIG. 8 is a diagram for describing a process for matching images obtained by cameras.

The cameras 111, 112, 113, and 114 shown in FIG. 3 may have overlapping fields of view, and the processor 130 may match images corresponding to the areas in which the fields of view overlap each other. For example, the first area Al shown in FIG. 8 may be an area where images captured by the front camera 111 and the left-side camera 113 overlap, and the third area A3 may be an area where images captured by the rear camera 112 and the left-side camera 113 overlap. The fifth area A5 may be an area where the images captured by the rear camera 112 and the right-side camera 114 overlap, and the seventh area A7 may be an area where the images captured by the front camera 111 and the right-side camera 114 overlap.

Furthermore, when a road surface has a slope, the same entrance point may be detected at different coordinate values in images obtained by different cameras. For example, a certain first entrance point belonging to the first area A1 may be detected at first position coordinates in an image captured by the front camera 111 and at second position coordinates in an image obtained by the left-side camera 113. The first position coordinates and the second position coordinates may be different coordinates.

The processor 130 may be configured to determine a mismatch of the coordinates of the entrance point based on a height difference between the first position coordinates and the second position coordinates.

A method of determining a mismatch between the first position coordinates and the second position coordinates when the first position coordinates are P_{w}_{₀}(x_{w}_{₀}, y_{w}_{₀}, 0) and the second position coordinates are P_{w}_{₁}(x_{w}_{₁}, y_{w}_{₁}, 0) will be described below. In the following description, the description will focus on an embodiment where the first position coordinates is the coordinates of an entrance point in an image captured by the front camera 111 and the second position coordinates are the coordinates of an entrance point in an image captured by the left-side camera 113.

The processor 130 may use extrinsic parameters of the cameras to obtain the first camera coordinates (P_{c}_{₀}) and the second camera coordinates (P_{c}_{₁}) as shown in Equation 4. The extrinsic parameters may include a rotation matrix and a transformation matrix for camera calibration.

$$\begin{matrix}{P}_{{c}_{0}} ( {x}_{{c}_{0}} , {y}_{{c}_{0}} , {z}_{{c}_{0}} ) = {R}_{0} * {P}_{{w}_{0}} + {T}_{0} \\ {P}_{{c}_{1}} ( {x}_{{c}_{1}} , {y}_{{c}_{1}} , {z}_{{c}_{1}} ) = {R}_{1} * {P}_{{w}_{1}} + {T}_{1}\end{matrix} \qquad [ Equation 4 ]$$

In [Equation 4], R₀ may denote a rotation matrix of the front camera 111, and may denote a transformation matrix of the front camera 111. R₁ may denote the rotation matrix of the left-side camera 113, and T₁ may denote the transformation matrix of the rear camera 112. The first camera coordinates (P_{c}_{₀}) and the second camera coordinates (P_{c}_{₁}) may be coordinates in a camera coordinate system.

The processor 130 may convert the first camera coordinates (P_{c}_{₀}) and the second camera coordinates (P_{c}_{₁}) into first normalized coordinates (P_{Norm}_{₀}) and second normalized coordinates (P_{Norm}_{₁}), respectively, as shown in [Equation 5].

$$\begin{matrix}{P}_{{Norm}_{0}} ( \frac{{x}_{{c}_{0}}}{{z}_{{c}_{0}}} , \frac{{y}_{{c}_{0}}}{{z}_{{c}_{0}}} , 1 ) \\ {P}_{{Norm}_{1}} ( \frac{{x}_{{c}_{1}}}{{z}_{{c}_{1}}} , \frac{{y}_{{c}_{1}}}{{z}_{{c}_{1}}} , 1 )\end{matrix} \qquad [ Equation 5 ]$$

The world coordinates obtained based on each of the first normalized coordinates (P_{Norm}_{₀}) and the second normalized coordinates (P_{Norm}_{₁}) may be expressed as [Equation 6].

$$[ Equation 6 ]$$

$${P}_{w} = {R}_{o}^{T} * ( {{z}_{{c}_{0}}}^{′} * {P}_{{Norm}_{0}} — {T}_{0} ) \qquad ( 6 - 1 )$$

$${P}_{w} = {R}_{1}^{T} * ( {{z}_{{c}_{1}}}^{′} * {P}_{{Norm}_{1}} - {T}_{1} ) \qquad ( 6 - 2 )$$

[Equation 6] may be the result of multiplying each of the first normalized coordinates (P_{Norm}_{₀}) and the second normalized coordinates (P_{Norm}_{₁}) by a height value and applying camera calibration. In [Equation 6],

$${z}_{{c}_{0}}^{′}$$

may be the answer height in the first position coordinate, and

$${z}_{{c}_{1}}^{′}$$

may be the answer height in the second position coordinates.

Because the world coordinates based on the first normalized coordinates expressed as (6-1) and the world coordinates based on the second normalized coordinates expressed as (6-2) in [Equation 6] are equal to each other, [Equation 6] may be expressed as [Equation 7].

$${{z}_{{c}_{0}}}^{′} * {R}_{0}^{T} * {P}_{{Norm}_{0}} - {{z}_{{c}_{1}}}^{′} * {R}_{1}^{T} * {P}_{{Norm}_{1}} = {R}_{0}^{T} * {T}_{0} - {R}_{1}^{T} * {T}_{1} \qquad [ Equation 7 ]$$

[Equation 7] may be expressed as three equations Eq1 to Eq3 as shown in the following [Equation 8].

$$\begin{matrix}[ Equation 8 ] & \\ {z}_{{c}_{0}}^{′} \times {c}_{0} - {z}_{{c}_{1}}^{′} \times {c}_{1} = {Const}_{2} & Eq1\end{matrix}$$

$${z}_{{c}_{0}}^{′} \times {b}_{0} - {z}_{{c}_{1}}^{′} \times {b}_{1} = {Const}_{1} \qquad Eq2$$

$${z}_{{c}_{0}}^{′} \times {a}_{0} - {z}_{{c}_{1}}^{′} \times {a}_{1} = {Const}_{0} \qquad Eq3$$

For each equation, solutions

$$( {z}_{{c}_{0}}^{′} , {z}_{{c}_{1}}^{′} )$$

of a total of three pairs may be obtained and each of the solutions are substituted into the other two equations to obtain three error values, Error 1 to Error 3. For example, the processor 130 may substitute a pair of height coordinates

$$( {z}_{{c}_{0}}^{′} , {z}_{{c}_{1}}^{′} )$$

obtained using Eq1 and Eq2 into Eq3 to determine a first error represented by

$$( {z}_{{c}_{0}}^{′} * {c}_{0} - {z}_{{c}_{1}}^{′} * {c}_{1} - {Const}_{2} ) .$$

Further, the processor 130 may determine a second error, represented by

$$( {z}_{{c}_{0}}^{′} * {b}_{0} - {z}_{{c}_{1}}^{′} * {b}_{1} - {Const}_{1} ) .$$

by substituting a pair of height coordinates

$$( {z}_{{c}_{0}}^{′} , {z}_{{c}_{1}}^{′} )$$

obtained using Eq1 and Eq3 into Eq2. Further, the processor 130 may determine a third error, represented by

$$( {z}_{{c}_{0}}^{′} * {a}_{0} - {z}_{{c}_{1}}^{′} * {a}_{1} - {Const}_{0} ) ,$$

by substituting a pair of height coordinates

$$( {z}_{{c}_{0}}^{′} , {z}_{{c}_{1}}^{′} )$$

obtained using Eq2 and Eq3 into Eq1.

When the first position coordinates (P_{w}_{₀}) and the second position coordinates (P_{w}_{₁}) are the same as the actual position coordinates of the entrance point, the first error to the third error may all be determined to be less than the threshold error.

When the first error, the second error, and the third error are all less than the threshold error, the processor 130 may calibrate the position coordinates to generate calibrated coordinates, as described later. The calibrated coordinates may be expressed as coordinates of an entrance point in the top-view image, in a process of matching the image captured by the first camera with the image captured by the second camera.

The processor 130 may be configured to generate the calibrated coordinates

$${P}_{w}^{′} ( {x}_{w}^{′} , {y}_{w}^{′} , {z}_{w}^{′} )$$

based on a weighted average by a distance for the coordinate values.

The processor 130 may be configured to determine the z-axis coordinate based on the distance difference between the first position coordinates and the second position coordinates on the xy plane, as shown in Equation 9.

$${x}_{{w}_{0}}^{′} = {x}_{{w}_{1}}^{′} , {y}_{{w}_{0}}^{′} = {y}_{{w}_{1}}^{′} , {z}_{{w}_{0}}^{′} \neq {z}_{{w}_{1}}^{′} \qquad [ Equation 9 ]$$

$${p}_{{z}_{0}} = \frac{EuclideanDist ( {P}_{{w}_{1}} , {P}_{{w}_{1}}^{′} )}{EuclideanDist ( {P}_{{w}_{0}} , {P}_{{w}_{0}}^{′} ) + EuclideanDist ( {P}_{{w}_{1}} , {P}_{{w}_{1}}^{′} )} , {p}_{{z}_{1}} = 1 - {p}_{{z}_{0}}$$

$${z}_{w}^{′} = {p}_{{z}_{0}} * {z}_{{w}_{0}}^{′} + {p}_{{z}_{1}} * {z}_{{w}_{1}}^{′}$$

In [Equation 9 EuclideanDist may represent Euclidean distance. p_{z}_{₀} may denote the first weight, and p_{z}_{₁} may denote the second weight. The sum of the first weight and the second weight may be 1. The first weight and the second weight may be set to be large in proportion to the distance difference between the first position coordinates and the calibrated coordinates.

Similarly, the processor 130 may be configured to determine the y-axis coordinate based on the distance difference between the first position coordinates and the second position coordinates in the xz plane, as shown in [Equation 10].

$${x}_{{w}_{0}}^{′} = {x}_{{w}_{1}}^{′} , {y}_{{w}_{0}}^{′} \neq {y}_{{w}_{1}}^{′} , {z}_{{w}_{0}}^{′} = {z}_{{w}_{1}}^{′} \qquad [ Equation 10 ]$$

$${p}_{{y}_{0}} = \frac{EuclideanDist ( {P}_{{w}_{1}} , {P}_{{w}_{1}}^{′} )}{EuclideanDist ( {P}_{{w}_{0}} , {P}_{{w}_{0}}^{′} ) + EuclideanDist ( {P}_{{w}_{1}} , {P}_{{w}_{1}}^{′} )} , {p}_{{y}_{1}} = 1 - {p}_{{y}_{0}}$$

$${y}_{w}^{′} = {p}_{{z}_{0}} {y}_{{w}_{0}}^{′} + {p}_{{z}_{1}} * {y}_{{w}_{1}}^{′}$$

Based on the distance difference between the first position coordinates and the second position coordinates on the YZ plane, the processor 130 may be configured to determine the X-axis coordinate, as in [Equation 11].

$${x}_{{w}_{0}}^{′} \neq {x}_{{w}_{1}}^{′} , {y}_{{w}_{0}}^{′} = {y}_{{w}_{1}}^{′} , {z}_{{w}_{0}}^{′} \neq {z}_{{w}_{1}}^{′} \qquad [ Equation 11 ]$$

$${p}_{{x}_{0}} = \frac{EuclideanDist ( {P}_{{w}_{1}} , {P}_{{w}_{1}}^{′} )}{EuclideanDist ( {P}_{{w}_{0}} , {P}_{{w}_{0}}^{′} ) + EuclideanDist ( {P}_{{w}_{1}} , {P}_{{w}_{1}}^{′} )} , {p}_{{x}_{1}} = 1 - {p}_{{x}_{0}}$$

$${x}_{w}^{′} = {p}_{{x}_{0}} * {x}_{{w}_{0}}^{′} + {p}_{{x}_{1}} * {x}_{{w}_{1}}^{′}$$

Furthermore, when at least one of the first error, the second error, and the third error is greater than a threshold error, the processor 130 may not generate the calibrated coordinates.

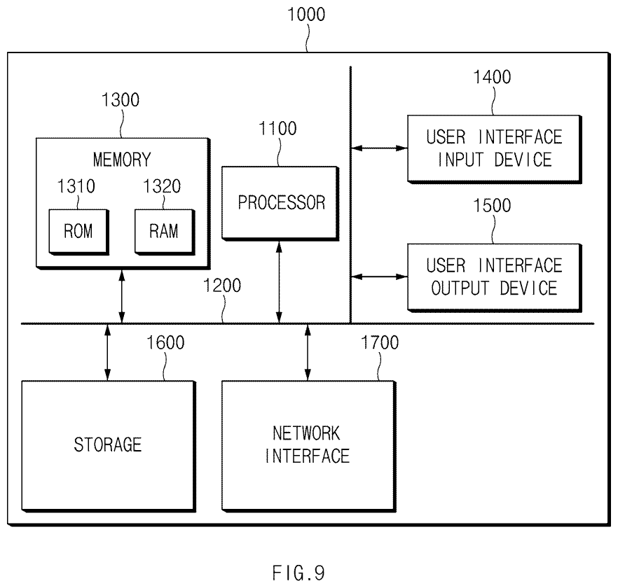

FIG. 9 illustrates a computing system according to an exemplary embodiment of the present disclosure.

Referring to FIG. 9, a computing system 1000 may include at least one processor 1100, a memory 1300, a user interface input device 1400, a user interface output device 1500, storage 1600, and a network interface 1700, which are connected to each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a Read Only Memory (ROM) and a Random Access Memory (RAM).

Thus, the operations of the method or the algorithm described in connection with the exemplary embodiments included herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM.

The exemplary storage medium may be coupled to the processor 1100, and the processor 1100 may read information out of the storage medium and may record information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The above description is merely illustrative of the technical idea of the present disclosure, and various modifications and variations may be made without departing from the essential characteristics of the present disclosure by those skilled in the art to which the present disclosure pertains.

Accordingly, the exemplary embodiment included in an exemplary embodiment of the present disclosure is not intended to limit the technical idea of the present disclosure but to describe the present disclosure, and the scope of the technical idea of the present disclosure is not limited by the embodiment. The scope of protection of the present disclosure should be interpreted by the following claims, and all technical ideas within the scope equivalent thereto should be construed as being included in the scope of the present disclosure.

According to the exemplary embodiments of the present disclosure, it is possible to improve the reliability of image recognition by more accurately matching images obtained from a plurality of cameras.

Furthermore, according to the exemplary embodiments of the present disclosure, it is possible to more accurately match images obtained from a plurality of cameras even when the road surface has a slope.

Furthermore, according to an exemplary embodiment of the present disclosure, it is possible to improve the performance of autonomous parking by accurately determining parking slots even when the road surface has a slope.

Furthermore, various effects may be provided that are directly or indirectly understood through the present disclosure.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A vehicle control apparatus comprising:
a first camera obtaining a first image in a range of a first field of view;
a second camera obtaining a second image in a range of a second field of view; and
a processor operatively connected to the first camera and the second camera and configured to recognize the first and second images to assist driving of a vehicle,
wherein the processor is configured to:
predict a movement of a reference point belonging to the first image captured at a first timing based on behavior information of the vehicle to determine an estimated position of the reference point at a second timing;
determine a slope of a road surface around the vehicle based on a difference between the estimated position and a detected position of the reference point in the first image captured at the second timing; and
based on that the slope of the road surface is greater than or equal to a predetermined level, perform calibration with respect to a difference between first position coordinates of the reference point in the first image and second position coordinates of the reference point in the second image.

2. The vehicle control apparatus of claim 1, wherein the processor is further configured to:
convert the first image into a top-view image; and
determine specified coordinates in the top-view image as the reference point.

3. The vehicle control apparatus of claim 1, wherein the behavior information of the vehicle includes a yaw rate of the vehicle and a speed of the vehicle.

4. The vehicle control apparatus of claim 3, wherein the processor is further configured to determine the estimated position based on a rotation matrix based on the yaw rate and a motion transformation matrix based on the speed.

5. The vehicle control apparatus of claim 1, wherein the processor is further configured to:
count a number of errors in which a difference between the estimated position and the detected position of the reference point in the first image, obtained at the second timing, falls within a predetermined range; and
determine the slope of the road surface based on that the number of errors exceeds a threshold count.

6. The vehicle control apparatus of claim 5, wherein the processor is further configured to reduce the threshold count as a speed of the vehicle decreases.

7. The vehicle control apparatus of claim 1, wherein the processor is further configured to determine a mismatch between the first position coordinates and the second position coordinates based on a difference between a height value of the first position coordinates and a height value of the second position coordinates.

8. The vehicle control apparatus of claim 7, wherein the processor is further configured to:
obtain first normalized coordinates based on the first position coordinates;
obtain second normalized coordinates based on the second position coordinates; and
determine the mismatch between the first position coordinates and the second position coordinates based on a height error between a first actual height of first world coordinates obtained by converting the first normalized coordinates and a second actual height of second world coordinates obtained by converting the second normalized coordinates.

9. The vehicle control apparatus of claim 1, wherein the processor is further configured to determine calibrated coordinates of the reference point based on a weighted average by a distance between the first position coordinates and the second position coordinates.

10. The vehicle control apparatus of claim 9, wherein the processor is further configured to determine a third axis coordinate of the calibrated coordinates based on a distance difference between the first position coordinates and the second position coordinates in a plane determined by a first axis and a second axis.

11. A vehicle control method comprising:
predicting, by a processor, a movement of a reference point belonging to a first image captured by a first camera operatively connected to the processor at a first timing based on behavior information of a vehicle to determine an estimated position of the reference point at a second timing;
determining, by the processor, a slope of a road surface around the vehicle based on a difference between the estimated position and a detected position of the reference point in the first image captured at the second timing; and
based on that the slope of the road surface is greater than or equal to a predetermined level, performing, by the processor, calibration with respect to a difference between first position coordinates of the reference point in the first image and second position coordinates of the reference point in a second image captured by a second camera operatively connected to the processor to generate calibrated coordinates.

12. The vehicle control method of claim 11, wherein the determining of the estimated position of the reference point at the second timing includes:
converting the first image into a top-view image; and
determining specified coordinates in the top-view image as the reference point.

13. The vehicle control method of claim 11, wherein the behavior information of the vehicle includes a yaw rate of the vehicle and a speed of the vehicle.

14. The vehicle control method of claim 13, wherein the determining of the estimated position of the reference point at the second timing includes determining the estimated position based on a rotation matrix based on the yaw rate and a motion transformation matrix based on the speed.

15. The vehicle control method of claim 11, wherein the determining of the slope of the road surface includes:
counting a number of errors in which a difference between the estimated position and the detected position of the reference point in the first image, obtained at the second timing, falls within a predetermined range; and
determining the slope of the road surface based on that the number of errors exceeds a threshold count.

16. The vehicle control method of claim 15, wherein the counting of the number of errors includes reducing the threshold count as a speed of the vehicle decreases.

17. The vehicle control method of claim 11, wherein the generating of the calibrated coordinates includes determining a mismatch between the first position coordinates and the second position coordinates based on a difference between a height value of the first position coordinates and a height value of the second position coordinates.

18. The vehicle control method of claim 17, wherein the determining of the mismatch between the first position coordinates and the second position coordinates includes:
obtaining first normalized coordinates based on the first position coordinates;
obtaining second normalized coordinates based on the second position coordinates; and
determining the mismatch between the first position coordinates and the second position coordinates based on a height error between a first actual height of first world coordinates obtained by converting the first normalized coordinate and a second actual height of second world coordinates obtained by converting the second normalized coordinates.

19. The vehicle control method of claim 11, wherein the generating of the calibrated coordinates includes generating calibrated coordinates of the reference point based on a weighted average by a distance between the first position coordinates and the second position coordinates.

20. The vehicle control method of claim 19, wherein the generating of the calibrated coordinates includes determining a third axis coordinate of the calibrated coordinates based on a distance difference between the first position coordinates and the second position coordinates in a plane determined by a first axis and a second axis.
